(19) United States
(12) Patent Application Publication
(10) Pub. No.: US 2009/0313249 A1
(43) Pub. Date: Dec. 17, 2009

(54) CREATIVE WORK REGISTRY INDEPENDENT SERVER

(76) Inventor: James D. Bennett, Hroznetin (CZ)

Correspondence Address: GARLICK HARRISON & MARKISON, P.O. BOX 160727, AUSTIN, TX, 78716-0727, US

(21) Appl. No.: 12/482,624

(22) Filed: Jun. 11, 2009

Related U.S. Application Data
(60) Provisional application No. 61/060,671, filed on Jun. 11, 2008.

(51) Int. Cl. G06F 17/30

(52) U.S. Cl. 707/6; 707/104.1; 707/E17.01; 707/E17.014

(57) ABSTRACT

An independent server (creative work protection server) that provides protection to the creative works of authors/artists by identifying web content in major third party host servers and other creative work content in database of the creative work protection server that contain similarities and reporting back to the authors/artists and major third party host servers. The creative works of the authors/artists may contain one or more of textual content, images, audio and video content. The creative work protection server has components that identify similarities to the works of the authors/artists (the creative works) and provide protection by assisting major third party host servers to delete the content, upon detection of similarities. The service to the authors/artists of the creative works is provided upon service charge basis. The creative work protection server provides provisions for registration, logging in, billing and to receive periodic results via email or webpage interface.

### CROSS REFERENCES TO RELATED APPLICATIONS

The present application claims priority under 35 U.S.C. 119(e) to U.S. Provisional Application Ser. No. 61/060,671, filed Jun. 11, 2008, and having a common title with the present application, which is incorporated herein by reference in its entirety for all purposes.

### BACKGROUND

1. Technical Field

The present invention relates generally to Internet infrastructures; and, more particularly, to creative work protection.

2. Related Art

Many websites allow their users to, freely or upon some service charge, upload and post their family audio, video, texts and images and allow public to view or download these posted content. That is, these third party servers are specifically set up for public viewing, access, and download, with minimal supervision. But some of these media may be copyrighted, are posted without permission of the respective authors/artists. Some of these are major websites having multitude of postings, the websites themselves often are unable to identify copyright violations of authors/artists of some of these posted audio, video, texts and images content. The authors/artists also find it hard to constantly monitor these websites for violations of their rights.

There are many difficulties in identifying copyright violations that occur in these websites by their users. For example, the posting can happen from anywhere around the world and the authors/artists may have limited jurisdiction to follow upon these users located in remote locations of the world. The websites who accept these posting often do not know who posts what, except if specifically informed so. Thus these websites unwittingly enable millions of users to become violators of copyright laws. In addition, the postings constantly change, with new postings containing audio, video, texts and images content added every moment and thus making it necessary to monitor constantly.

Authors/artists spend huge sums to monitor violations of their works in these websites, and often end up unsuccessful in their efforts. Since, the website content constantly change, the authors/artists may have to monitor constantly, which makes effort as well as financial expenses prohibitive. To all these efforts the authors/artists often get very little in return. Many websites that accept posting of material have, in principle, mechanisms involved to erase these materials from their sites if they receive feedback from users, but they don't work efficiently, and need to be monitored constantly.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block diagram illustrating an Internet infrastructure containing a client device, major third party host servers and a (web browser accessible) creative work protection server, wherein the creative work protection server provides protection for creative works containing texts, images, video and audio recordings by identifying similarities with web content in the major third party host servers and database of the creative work protection server containing texts, images, video and audio recordings, respectively, and reporting back to registered owners of the creative works and major third party host servers;

FIG. 2 is an exemplary schematic block diagram illustrating snap shot of a registration/login page, that assists owners of creative works to register or login to the creative work protection server of FIG. 1;

FIG. 3 is an exemplary schematic block diagram illustrating snap shot of an upload page, that assists owners of creative works to upload their works to the creative work protection server of FIG. 1;

FIG. 4 is an exemplary schematic block diagram illustrating snap shot of a result page containing vital details of the creative work containing text and report of similarities in the respective content of database of the creative work protection server and of the major third party host servers of FIG. 1;

FIG. 5 is an exemplary schematic block diagram illustrating snap shot of a result page containing vital details of the creative work containing video content and report of similarities in the respective content of database of the creative work protection server and of the major third party host servers of FIG. 1;

FIG. 6 is a schematic block diagram illustrating components of the creative work protection server constructed in accordance with the embodiment of FIG. 1 of the present invention;

FIG. 7 is a schematic block diagram illustrating components of the creative work protection server constructed in accordance with the embodiment of FIG. 1, in continuation of FIG. 6;

FIG. 8 is a flow diagram illustrating functionality of the creative work protection server of FIG. 1, wherein the creative work protection server identifies and reports similarity in creative works containing textual content and images;

FIG. 9 is a flow diagram illustrating functionality of the creative work protection server of FIG. 1 in detail, with the creative work containing texts in consideration;

FIG. 10 is a flow diagram illustrating functionality of the creative work protection server of FIG. 1 in detail, with the creative work containing images in consideration;

FIG. 11 is a flow diagram illustrating functionality of the creative work protection server of FIG. 1 in detail, wherein the creative work protection server identifies and reports similarity in creative works containing audio and video content; and

FIG. 12 is a flow diagram illustrating functionality of the creative work protection server of FIG. 1 in detail, with the creative work containing audio-video content in consideration.

### DETAILED DESCRIPTION OF THE DRAWINGS

The following figures illustrate various embodiments of creative works infrastructures that support creative works rights protection, revenue collection, and user, author, owner interfacing. Creative works may be textual, images, video, audio and video with associated audio. In each of the embodiments, attempts are made to identify copies or derivatives of such creative works and to identify unauthorized attempts of storage or distribution and, if so configured, offer licensing and associated fee collection. An author/owner need only register at least some portion of their creative works into some type of registry database and comparisons can be made with a user's file or stream.

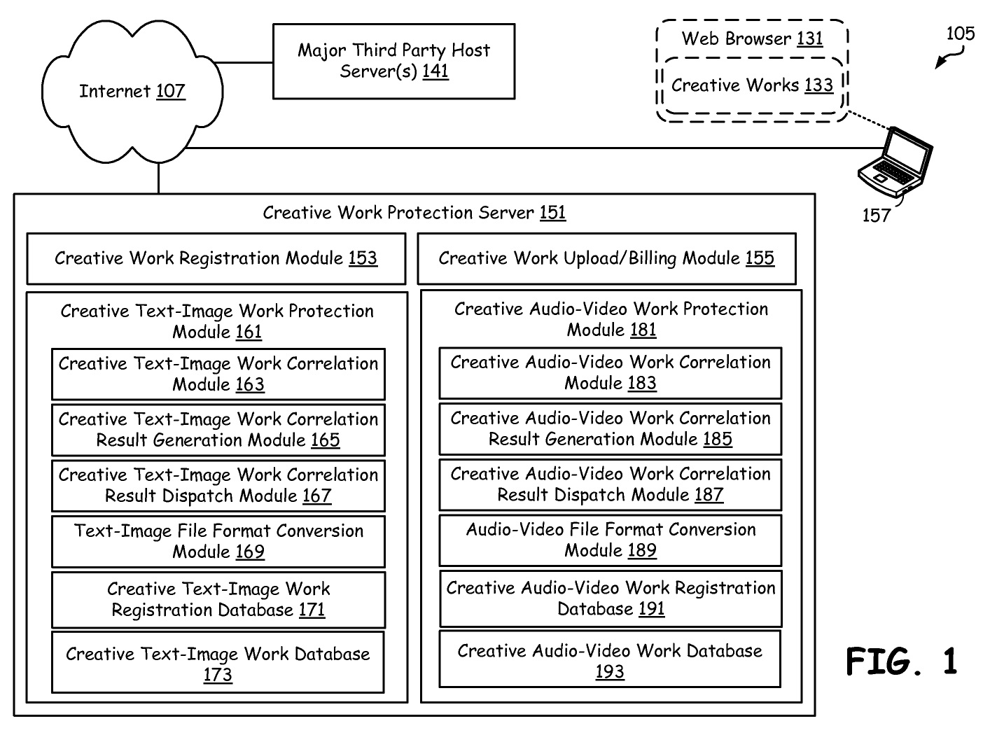

FIG. 1 is a schematic block diagram illustrating an Internet infrastructure 105 containing a client device 157, major third party host servers 141 and a (web browser accessible) creative work protection server 151, wherein the creative work protection server 151 provides protection for creative works 133 containing texts, images, video and audio recordings by identifying similarities with web content in the major third party host servers 141 and database of the creative work protection server 151 containing texts, images, video and audio recordings, respectively, and reporting back to registered owners of the creative works and major third party host servers 141. Specifically, the creative work protection server 151 provides protection to the creative works 133 (belonging to registered users of the creative work protection server 151), involving textual content, images, audio and video content, by comparing the creative works 133 with that of other creative works stored in database of the creative work protection server 151 and the major third party host servers 141, and generating report about results of comparison and reporting back to the registered owners of the creative works 133 and to the major third party host servers 141.

Typically, the comparison takes place only between similar content, both with the creative works in database of the creative work protection server 151 and plurality of the major third party host servers 141. That is, textual content of the creative works 133 are compared only with other textual content, video recordings are compared only with other video content, and so on. During comparison, any similarities between the content of the creative works 133 and that of content of database of the creative work protection server 151 and plurality of the major third party host servers 141 imply likelihood of infringements of the rights of the registered owner and are reported back, for further actions. The process of comparison with plurality of web content in major third party host servers 141 occurs with mutual agreement, soon as the creative works 133 are loaded and billing agreement/payment are completed. The creative work protection server 151 compares with web content only once, thereafter periodic comparisons occur only between new or changed works, and reports are generated on this basis and reported back periodically. The creative work protection server 151, in addition to reporting similarities back to the registered owners, also performs additional tasks such as reporting to the major third party host servers 141 regarding the possibility of copyright violations and also taking some actions such as assisting to delete the web content, upon consideration, that violate copyright laws.

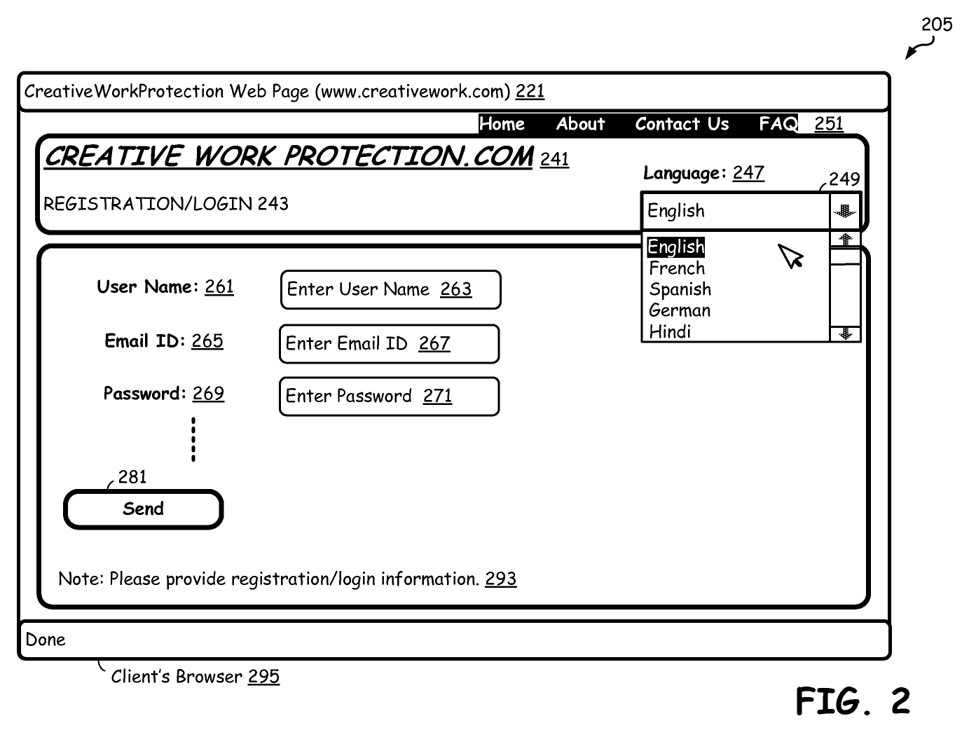

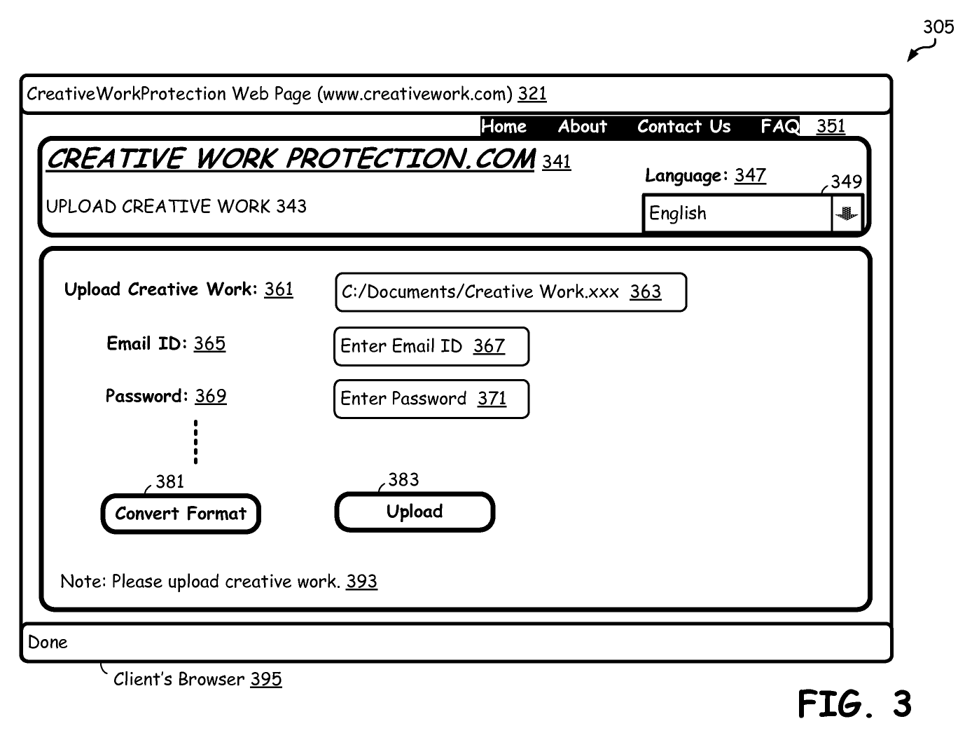

The creative work protection server 151 provides web page interfaces (refer to the FIG. 2 for an exemplary snapshot of registration/login webpage interface) to the owners of creative works 133 that allow them to provide some personal information that may include user name, password, date of birth, address, email address, etc. Once registered, the owners of creative works 133 are provided with web interfaces (refer to the FIG. 3 for an exemplary snapshot of upload webpage interface) to login any time of their choice and upload their creative works (the creative works may contain one or more of textual content, images, audio and/or video recordings) 133 via web browser 131 to the creative work protection server 151. The creative work files containing textual content and images may be any of the standard text, image formats such as Microsoft Word format, Abode Reader format, ‘.jpeg’ format, and ‘.bmp’ format. In case of audio and video recordings, the creative work files may be any of standard audio or video formats such as MP3, WMA, WAV, OGG, AVI, MPEG-1, MPEG-2, and WMV. In case of creative works containing texts and images, the creative work protection server 151 stores these files in a database and converts them to a suitable format by separating texts and images before further processing. In case of creative works containing audio and/or video recordings, the creative work protection server 151 stores these files in another database and converts them to a suitable format by: (i) In case of audio, to a predetermined audio format such as WAV; and (ii) In case of video, by separating audio and video portions and then converting them to a predetermined audio and video formats such as WAV and MPEG-2 respectively.

Once the creative works 133 are uploaded, the creative work protection server 151 initiates a billing process based upon certain criteria. The billing may occur at the time of uploading or periodically. For example, for creative works with textual content and/or images, the billing may be based upon a fixed price/creative work 133, fixed price/number of characters in textual content of the creative work 133, fixed price/image size/image of the creative work 133, fixed price/report generated for a predetermined period such as a week or month, etc. For creative works containing audio and video recordings, the billing may be based upon a fixed price/creative audio work, fixed price/creative video work, fixed price/minute of the creative audio-video work, fixed price/report generated for a predetermined period such as a week or month, etc.

After the creative works 133 are acquired and stored and the billing process/agreement are completed, the creative work protection server 151 begins processing creative works 133 containing textual content and/or images by segregating textual content and images and then converting them to a standard predetermined format and again storing them. Then, the processing by the creative work protection server 151 continues, by accessing the web content in the major third party host servers 141 and database content in the creative work protection server 151 containing textual content and/or images, storing them temporarily in a database. Then the creative work protection server 151 separates them into textual content and images and converts these to the same predetermined format. Then, the creative work protection server 151 compares the textual content of converted creative work with that of converted web content and database content and generates a report if similarities are identified. These reports are stored in a database. Also, for an additional fee, the creative work protection server 151 reports the similarities to the major third party host servers 141 via some arrangement with these major third party host servers 141 and automatically assists in deleting the web content.

Similarly, in case of creative works containing audio and/or video recordings, the processing by the creative work protection server 151 continues by accessing the web audio or video content or file attachments in the major third party host servers 141 and database content of the creative work protection server 151, storing them temporarily in a database. Then the creative work protection server 151, in case of audio recordings, converts them to the same predetermined format that was used in case of creative work 133 containing audio recordings. In case of video recordings, the creative work protection server 151 separates audio and video portions, converts them to the same predetermined formats that were used in case of creative work 133 containing video recordings. Then, the creative work protection server 151 compares the audio or video content of converted creative work with that of converted web audio and video content and database content, and generates a report if similarities are identified. These reports are stored in a database. Also, for an additional fee, the creative work protection server 151 reports the similarities to the major thirds party host servers 141 and automatically or by consideration assists in deleting the web content. Alternatively, the creative work protection server 151 may also provide provisions for fees for each upload and download of the web content available in major third party host servers 141.

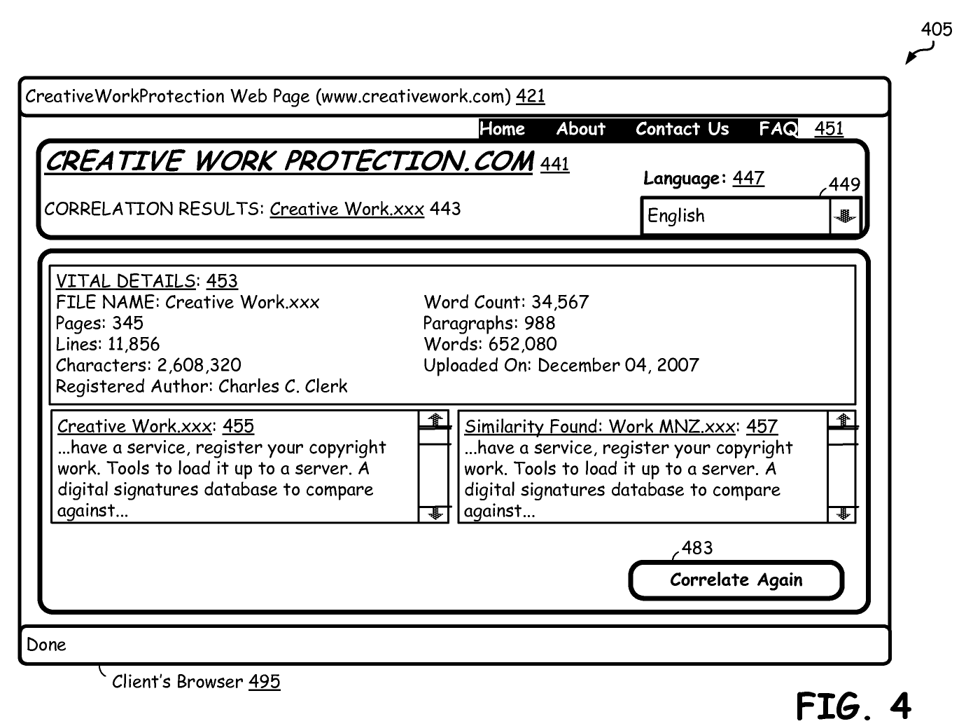

In case of creative works 133 containing textual content, the comparison between the textual content of converted creative work and that of converted web content and database content occur in one of many possible ways. The first among them is comparison of keywords or phrases (partially determined by the registered owner of the creative work 133) between the two textual content. This may be specifically applicable if the keywords or phrases are registered or copyrighted. Any matches would be considered as containing similarities. The second among these identifies number of words or number of sentences that contain similarities between these two textual content by comparing character by character. The similarities are considered to be identified if the number of adjacent characters match beyond a correlation threshold. The correlation threshold may be, for example, 20 adjacent characters or 20 adjacent words. Once this correlation threshold is exceeded, the creative work protection server 151 continues to compare until all of the similarities are identified and then generates a report on this basis (refer to the FIG. 4 for an exemplary snapshot of report). Other methods of comparison are also contemplated.

In case of creative works 133 containing images, the correlation between the image content of converted creative work and that of converted web content and database content occur on the basis of pixel by pixel comparison. The converted images are resized to a predetermined standard size and then are compared pixel by pixel for identifications of similarities. A correlation threshold may determine that a similarity is identified. Once this correlation threshold is exceeded (which might be number of adjacent pixels), for example, the creative work protection server 151 continues to compare until all of the similarities are identified and then generates a report on this basis. Other methods of comparison are also contemplated.

In case of creative works 133 containing audio recordings, the comparison occurs in one of many possible ways. The first among them is bit by bit comparison. The similarities are considered to be identified if the number of adjacent bits match beyond a correlation threshold. The correlation threshold may be, for example, 256 adjacent bits. Once this correlation threshold is exceeded, the creative work protection server 151 continues to compare until all of the similarities are identified and then generates a report on this basis. Alternatively, to identify those web audio content having similarities, that are manipulated in someway (such as recording using a microphone), the creative work protection server 151 may resort to converting the recordings to analog forms and then comparing them. Other methods of comparison are also contemplated.

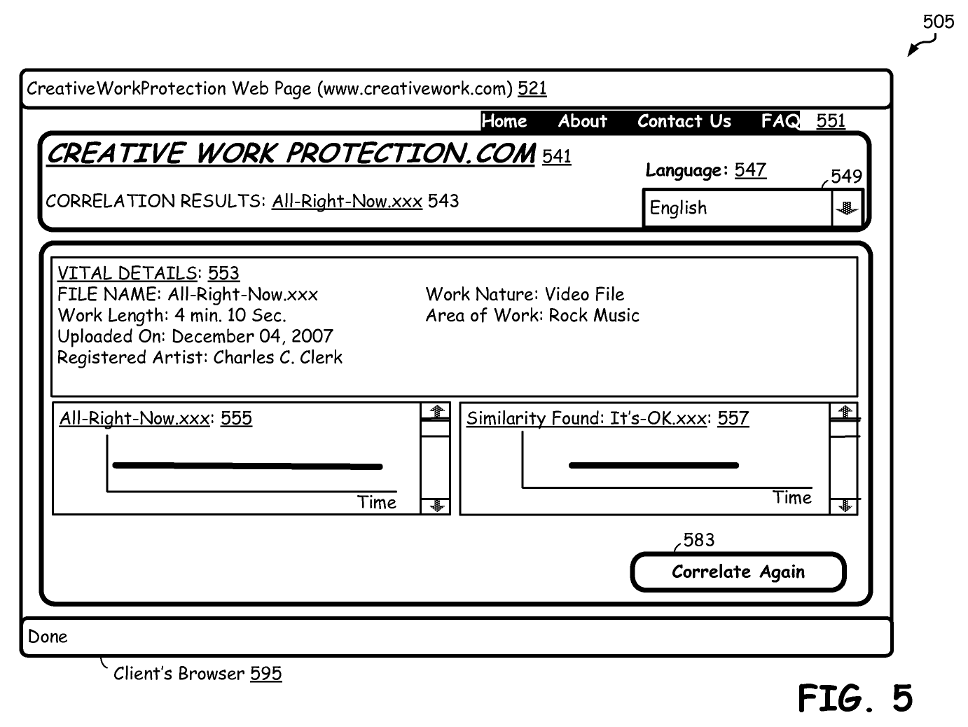

In case of creative works 133 containing video recordings, the digital signatures are identified and compared as a first step. As a next step, the comparison of audio portion of the video recording is performed, which occurs in a similar fashion as the comparison that occurs in case of audio recordings mentioned before. If no similarities are found, the video portion of the recording may be compared. This occurs on the basis of frame by frame comparison. The similarities are considered to be identified if the number of adjacent frames match beyond a correlation threshold. The correlation threshold may be, for example, 256 adjacent frames. Once this correlation threshold is exceeded, the creative work protection server 151 continues to compare until all of the similarities are identified and then generates a report on this basis. Other methods of comparison are also contemplated. The reports may be presented in case of both audio and video recordings, in a graphical manner (refer to the FIG. 5 for an exemplary snapshot of report).

The creative work protection server 151 contains plurality of modules to enable the functionalities mentioned in the above paragraphs. The creative work protection server 151 contains creative work registration module 153 and creative work upload/billing module 155 to perform functions of registration, logging in and billing. The creative work protection server 151 also contains two major modules, viz., creative text-image work protection module 161, and creative audio-video work protection module 181. The creative text-image work protection module 161 contains creative text-image work correlation module 163 which performs textual content and image comparisons, creative text-image work correlation result generation module 165 which generates reports, creative text-image work correlation result dispatch module 167 which delivers reports to the registered owners and/or major third party host servers 141 and text-image file format conversion module 169. The creative text-image work protection module 161 also contains few databases to store data such as registration information and uploaded creative text-image works. The creative text-image work protection module 161 contains creative text-image work registration database 171 and creative text-image work database 173.

The creative audio-video work protection module 181 contains creative audio-video work correlation module 183 which performs audio and video comparisons, creative audio-video work correlation result generation module 185 which generates reports, creative audio-video work correlation result dispatch module 187 which delivers reports to the registered owners and/or major third party host servers 141 and audio-video file format conversion module 189. The creative audio-video work protection module 181 also contains creative audio-video work registration database 191 and creative audio-video work database 193.

For example, an author of a copyrighted material (that contains several pages of written text and few images or diagrams), may want to protect his/her work being downloaded from major third party host servers 141. Therefore, the author decides to register with the service of the creative work protection server 151. After registration, the author may upload electronic version of his/her work in a standard file format and fulfill the billing obligations.

Then, the creative work protection server 151 stores this file, segregates textual content from images or diagrams. The creative work protection server 151 then converts these textual content and images or diagrams to a predetermined format. For example, the textual content may be converted to ‘.txt’ format while the diagrams or images may be converted to ‘.jpg’ format. Then, the creative work protection server 151 begins to acquire the web content and database content and begins the comparison process. If no similarities are found, then no reports are generated and the process temporarily ends there. On the contrary, if similarities are detected, then the creative work protection server 151 generates report that may contain major third party host server 141 details, vectors associated with the web content as well as the areas of similarity in textual content and images and stores them in a database. Then, the accumulated reports over a predetermined period of time such as a day, week or month are formatted in a readable manner and submitted to the viewing of the author. The reports may be sent via email to the author, or may be made available on a webpage upon logging into the creative work protection server 151. If requests are made by the author for additional services such as sending reports to the major third party host server 141, then the reports are generated and sent to the major third party host server 141 for further consideration.

In another example, an artist of a copyrighted rock music video, may want to prevent his/her work being downloaded (or played) from the major third party host servers 141 without permission. Therefore, the artist may decide to register with the creative work protection service of the creative work protection server 151. After registration, the artist may upload, for example, a MPEG-2 format video recording of the rock music and fulfill the billing obligations. Alternatively, the creative work protection server 151 also allows the artist to upload the rock music video in many possible formats.

Then, the creative work protection server 151 stores the rock music video file. Then, the creative work protection server 151 converts the audio and video potions of the video recording to predetermined formats. Then, the creative work protection server 151 begins to acquire the video content from the major third party host servers 141 and database video content of the creative work protection server 151 and begins the comparison process. If no similarities are found, then no reports are generated and the process temporarily ends there. On the contrary, if similarities are detected, then the creative work protection server 151 generates report that may contain major third party host server 141 details, vectors associated with the video content as well as the areas of similarity in the rock music video and stores them in a database. Then, the accumulated reports over a predetermined period of time such as a day, week or month are formatted in a readable manner and submitted to the viewing of the artist, either via email or via webpage interface upon logging into the creative work protection server 151.

FIG. 2 is an exemplary schematic block diagram illustrating snap shot of a registration/login page that assists owners of creative works to register or login to the creative work protection server of FIG. 1. Specifically, the exemplary snap shot illustrated shows a creative work registration/login page 205 delivered to a client's browser 295 of client device, that allow owners of creative works to register and login by providing some personal information that may include user name, password, date of birth, address, email address, etc. The creative work registration/login page 205 delivered may contain a page title such as ‘CreativeWorkProtection Web Page (www.creativework.com)’ 221. It may also contain a title such as ‘CREATIVE WORK PROTECTION.COM’ 241 and a tool bar 251 providing access to other pages of the creative work protection server. A language 247 selection tool 249 may also be provided, that allows user to choose a language in these pages. A sub-title that briefly explains the page content such as ‘REGISTRATION/LOGIN’ 243 may also be provided.

One of the windows in the creative work registration/login page 205 may request the owners of creative works for details such as user name 261, email ID 265, password 269 etc. by providing text boxes 263, 267 and 271. A ‘Send’ 281 button allows the owners of creative works to complete the registration formalities. Once registered, the owners may login any time of their choice and upload their creative works and view the results of comparisons. A helpful text such as ‘Note: Please provide registration/login information’ 293 may also be provided.

FIG. 3 is an exemplary schematic block diagram illustrating snap shot of an upload page that assists owners of creative works to upload their works to the creative work protection server of FIG. 1. In specific, the exemplary snap shot illustrated shows a creative work upload page 305 delivered to a client's browser 395 of client device, that allow owners of creative works to upload, after logging into the creative work protection server. The creative work upload page 305 delivered may contain a page title such as ‘CreativeWorkProtection Web Page (www.creativework.com)’ 321. It may also contain a title such as ‘CREATIVE WORK PROTECTION.COM’ 341 and a tool bar 351 providing access to other pages of the creative work protection server. A language 347 selection tool 349 may also be provided, that allows user to choose a language in these pages. A sub-title that briefly explains the page content such as ‘UPLOAD CREATIVE WORK’ 343 may also be provided.

One of the windows in the creative work upload page 305 may request the owners of creative works for login details such as email ID 365, password 369 and by providing text boxes 367 and 371. Alternatively, login webpage may be provided separately from that of creative work upload page 305. In addition, an upload creative work 361 title followed by a text box 363 that allows the registered owners to enter address of the creative work. The creative work upload page 305 may also provide browsing facilities that allow registered owners to browse through the personal computer and open the file to be uploaded automatically. A ‘Convert Format’ 381 button allows registered owners to convert format of the creative work document to any other formats (this is optional). An ‘Upload’ 383 button allows the owners of creative works to send the creative work document to the creative work protection server. A helpful text such as ‘Note: Please upload creative work’ 393 may also be provided.

FIG. 4 is an exemplary schematic block diagram illustrating snap shot of a result page containing vital details of the creative work containing text and report of similarities in the respective content of database of the creative work protection server and of the major third party host servers of FIG. 1. Specifically, the exemplary snap shot illustrated shows a creative text work correlation (comparison) results page 405 delivered to a client's browser 495 of client device, containing vital statistics of the creative text work and selected portions of texts that are similar. The creative text work correlation results page 405 delivered may contain a page title such as ‘CreativeWorkProtection Web Page (www.creativework.com)’ 421. It may also contain a title such as ‘CREATIVE WORK PROTECTION.COM’ 441 and a tool bar 451 providing access to other pages of the creative work protection server. A language 447 selection tool 449 may also be provided, that allows user to choose a language in the result pages. A sub-title that provides the name of the creative text work in consideration such as ‘CORRELATION RESULTS: Creative Work.xxx’ 443 may also be provided.

One of the windows in the creative text work correlation results page 405 may provide vital statistics of the creative text work in consideration such as ‘VITAL DETAILS:’ 453 followed by details such as file name, word count, number of pages, number of paragraphs, number of lines, number of words, number of characters, uploaded on and registered author. Additional vital statistics related to the web text content, file attachments or other creative works in the database of creative work protection server in which the similarity is found such as web site, web page/file attachment link, web page/file statistics and the locations within the web page/file where similarity is found may also be provided in this window (not shown).

A second window illustrated provides the file name of the creative text work of a registered owner such as ‘Creative Work.xxx:’ 455 followed by the text where similarities are found. A third window illustrated provides the file name of the web text content posted by a third party server or database text content such as ‘Similarity Found: Work MNZ.xxx:’ 457 followed by the text that contains the similarities. The author may be able to decide whether to ignore the similarity found or to take any necessary actions. Also, a ‘Correlate Again’ button 483 provides options to the author to continue to the next similarity either within the current web page/file text content or in another web page/file.

FIG. 5 is an exemplary schematic block diagram illustrating snap shot of a result page containing vital details of the creative work containing video content and report of similarities in the respective content of database of the creative work protection server and of the major third party host servers of FIG. 1. In specific, the exemplary snap shot illustrated shows a creative video work correlation (comparison) results page 505 delivered to a client's browser 595 of client device, containing vital statistics of the creative video work and graphical representation of areas of similarity. The creative video work correlation results page 505 delivered may contain a page title such as ‘CreativeWorkProtection Web Page (www.creativework.com)’ 521. It may also contain a title such as ‘CREATIVE WORK PROTECTION.COM’ 541 and a tool bar 551 providing access to other pages of the creative work protection server. A language 547 selection tool 549 may also be provided, that allows user to choose a language in the result pages. A sub-title that provides the name of the creative video work in consideration such as ‘CORRELATION RESULTS: All-Right-Now.xxx’ 543 may also be provided.

A first window in the creative video work correlation results page 505 may provide vital statistics of the creative video work in consideration such as ‘VITAL DETAILS:’ 553 followed by details such as file name, work nature, work length, area of work, uploaded on and registered artist. Additional vital statistics related to the web video content, file attachments or database content in which the similarity is found such as web site, web video content/file attachment link, web video content/file statistics and the locations within the web video content/file where similarity is found may also be provided in this window (not shown).

A second window illustrated provides the file name of the creative video work of a registered owner such as ‘All-Right-Now.xxx:’ 555 followed by some graphical representation of the length of the creative video work. A third window illustrated provides the file name of the web video content/file attachment posted by a third party server such as ‘Similarity Found: It's-OK.xxx:’ 557 followed by a graphical representation similar to that of the second window depicting the areas where similarity found. The artist is able to take necessary actions based upon observation of displayed similarities. Also, a ‘Correlate Again’ button 583 provides options to the artist to continue to the next similarity in another web video content/file.

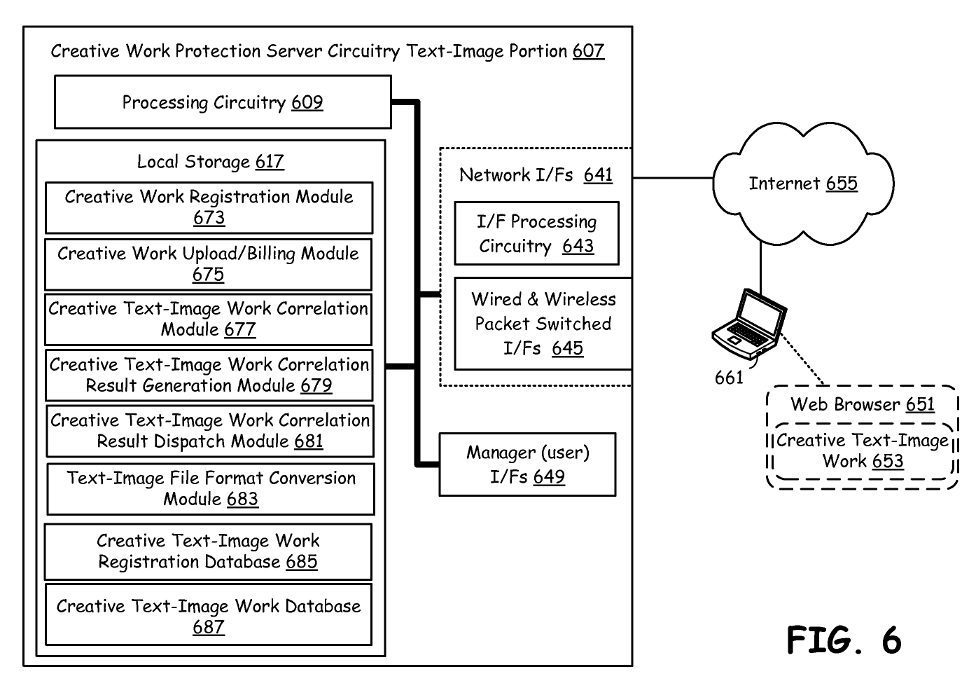

FIG. 6 is a schematic block diagram illustrating components of the creative work protection server constructed in accordance with the embodiment of FIG. 1 of the present invention. The creative work protection server circuitry text-image portion 607 may in part or full be incorporated into any computing device that operates as an Internet based server. The creative work protection server circuitry text-image portion 607 generally includes processing circuitry 609, local storage 617, manager interfaces 649, and network interfaces 641. These components communicatively coupled to one another via one or more of a system bus, dedicated communication pathways, or other direct or indirect communication pathways. The processing circuitry 609 may be, in various embodiments, a microprocessor, a digital signal processor, a state machine, an application specific integrated circuit, a field programming gate array, or other processing circuitry.

Local storage 617 may be random access memory, read-only memory, flash memory, a disk drive, an optical drive, or another type of memory that is operable to store computer instructions and data. The local storage 617 includes creative work registration module 673 and creative work upload/billing module 675 to perform functions of registration, logging in and billing. In addition, the local storage 617 includes creative text-image work correlation module 677 which performs textual content and image comparisons, creative text-image work correlation result generation module 679 which generates reports, creative text-image work correlation result dispatch module 681 which delivers reports to the registered owners and/or host third party server (not shown) and that of creative text-image work database 687, and text-image file format conversion module 683. The local storage 617 also contains creative text-image work registration database 685 to store registration, logging in and billing information of the registered owners and the creative text-image work database 687 to store creative text-image work 653 of registered owners.

The network interfaces 641 contain wired and wireless packet switched interfaces 645 and may also contain built-in or an independent interface processing circuitry 643. The network interfaces 641 allow the creative work protection server circuitry text-image portion 607 to communicate with client devices such as 661 and to upload creative text-image works 653 via a web browser 651 and to deliver results. The manager interfaces 649 may include a display and keypad interfaces. These manager interfaces 649 allow the user at the creative work protection server circuitry text-image portion 607 to control aspects of the present invention. The client device 661 illustrated are communicatively coupled to the creative work protection server circuitry text-image portion 607 via an Internet 655.

In other embodiments, the creative work protection server circuitry text-image portion 607 of the present invention may include fewer or more components than are illustrated as well as lesser or further functionality. In other words, the illustrated creative work protection server circuitry text-image portion is meant to merely offer one example of possible functionality and construction in accordance with the present invention.

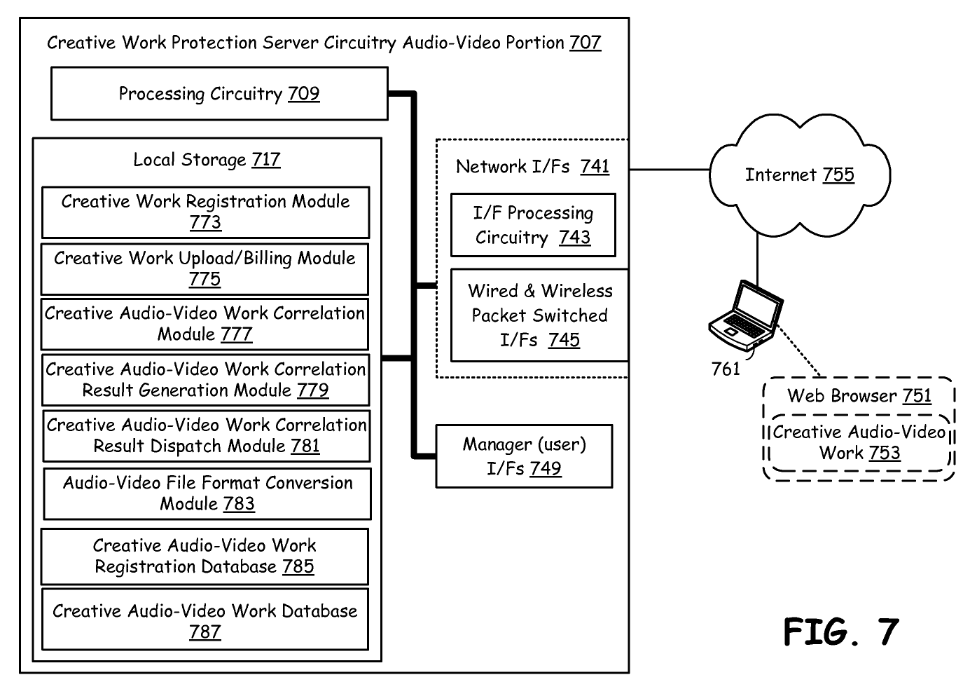

FIG. 7 is a schematic block diagram illustrating components of the creative work protection server constructed in accordance with the embodiment of FIG. 1, in continuation of FIG. 6. The creative work protection server circuitry audio-video portion 707 may in part or full be incorporated into any computing device that operates as an Internet based server. The creative work protection server circuitry audio-video portion 707 generally includes processing circuitry 709 (609 of FIG. 6), local storage 717 (617 of FIG. 6), manager interfaces 749 (649 of FIG. 6) and network interfaces 741 (641 of FIG. 6). These components communicatively coupled to one another via one or more of a system bus, dedicated communication pathways, or other direct or indirect communication pathways. The processing circuitry 709 may be, in various embodiments, a microprocessor, a digital signal processor, a state machine, an application specific integrated circuit, a field programming gate array, or other processing circuitry.

Local storage 717 may be random access memory, read-only memory, flash memory, a disk drive, an optical drive, or another type of memory that is operable to store computer instructions and data. The local storage 717 includes creative work registration module 773 (673 of FIG. 6) and creative work upload/billing module 775 (675 of FIG. 6) to perform functions of registration, logging in and billing. In addition, the local storage 717 includes creative audio-video work correlation module 777 which performs audio and video content comparisons between creative audio-video work 753 of registered owners and audio-video content of third party servers (not shown) and that of creative audio-video work database 787, creative audio-video work correlation result generation module 779 which generates reports, creative audio-video work correlation result dispatch module 781 which delivers reports to the registered owners and/or host third party server and audio-video file format conversion module 783. The local storage 717 also contains creative audio-video work registration database 785 to store registration, logging in and billing information of the registered owners and the creative audio-video work database 787 to store creative audio-video work 753 of the registered owners.

The network interfaces 741 contain wired and wireless packet switched interfaces 745 and may also contain built-in or an independent interface processing circuitry 743. The network interfaces 741 allow the creative work protection server circuitry audio-video portion 707 to communicate with client devices such as 761 and to upload creative audio-video works 753 via a browser 751 and to deliver results. The manager interfaces 749 may include a display and keypad interfaces. These manager interfaces 749 allow the user at the creative work protection server circuitry audio-video portion 707 to control aspects of the present invention. The client device 761 illustrated are communicatively coupled to the creative work protection server circuitry audio-video portion 707 via an Internet 755.

In other embodiments, the creative work protection server circuitry audio-video portion 707 of the present invention may include fewer or more components than are illustrated as well as lesser or further functionality. In other words, the illustrated creative work protection server circuitry audio-video portion is meant to merely offer one example of possible functionality and construction in accordance with the present invention.

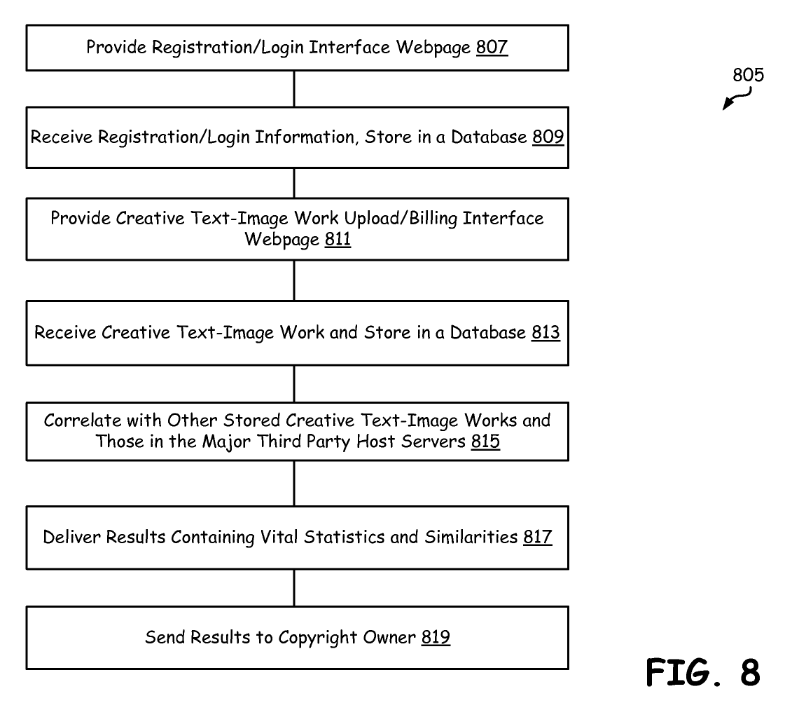

FIG. 8 is a flow diagram illustrating functionality 805 of the creative work protection server of FIG. 1, wherein the creative work protection server identifies and reports similarity in creative works containing textual content and images. The functionality of the creative work protection server that deals with creative text-image works begins at a block 807 when an owner of the creative text-image work is provided with registration/login interface webpage. At a next block 809, the creative work protection server that deals with creative text-image works receives registration information if the owner is interacting with the creative work protection server for the first time and stores this information in a database. In subsequent interactions, the creative work protection server verifies login information and allows the owner to access services of the creative work protection server. The registration information may contain user name, password, date of birth, address, email address and other relevant information.

At a next block 811, the creative work protection server provides creative text-image work upload/billing interface. The owner may upload any number of creative text-image works in subsequent visits (after initial registration), and the billing may occur on one of many possible ways. This includes a fixed price/creative text-image work, fixed price/number of characters in textual content of the creative text-image work, fixed price/image size/image of the creative text-image work, fixed price/report generated for a predetermined period such as a week or month, etc. That is, the billing may occur immediately after uploading of creative text-image works or may occur periodically based upon an agreement with the registered owner. And the service may be provided for a fixed period of time such as one year or two years depending upon agreement with the registered owner.

At a next block 813, the creative work protection server receives creative text-image works and stores them in a database. At a next block 815, the creative work protection server correlates the creative text-image work with that of web content in major third party host servers and creative text-image content of the database of creative work protection server. Then, creative work protection server generates a report containing all of the website links (together with vectors of web pages or files contained in the web sites) and titles of the database text-image content that contain texts or images having similarities with that of content of creative text-image works. At a next block 817, the creative work protection server delivers results containing vital statistics of the creative text-image works, along with similarities found. In a final block 819, the creative work protection server sends results to the registered owner, and upon agreement with registered owner and major third party host servers, to the major third party host servers.

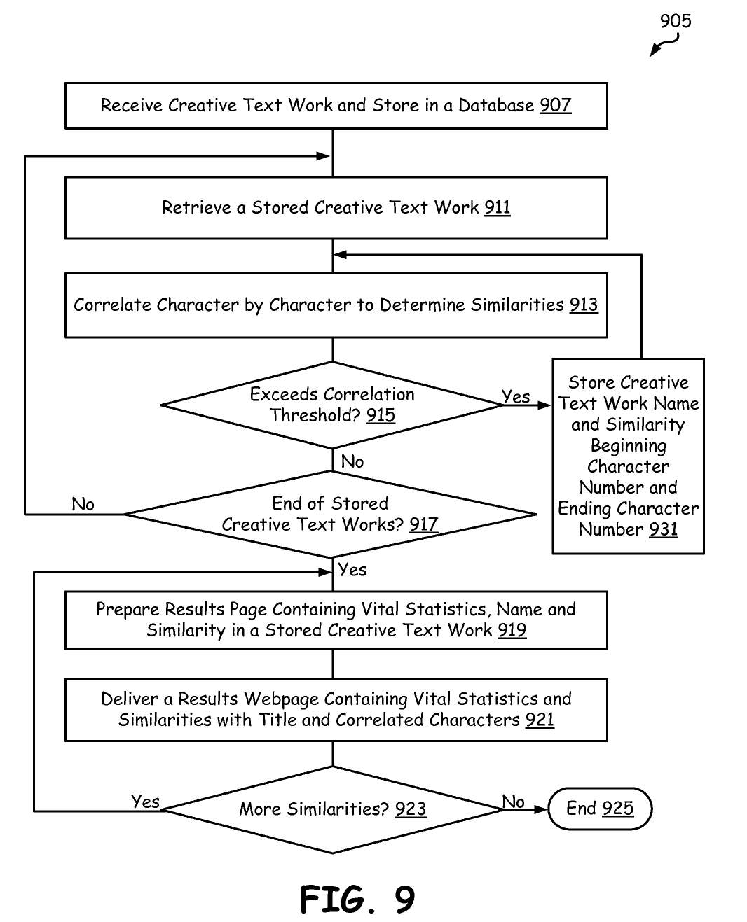

FIG. 9 is a flow diagram illustrating functionality 905 of the creative work protection server of FIG. 1 in detail, with the creative work containing texts in consideration. The detailed functionality concerning the creative work containing texts of a registered owner begins at a block 907, when the creative work protection server receives creative text works and stores them in a database. To make this possible, the creative work protection server provides webpage interfaces to the registered owner to upload one or more creative text works.

At a next block 911, the creative work protection server retrieves stored creative text work. At a next block 913, the creative work protection server correlates character by character with that of web text content in major third party host servers and that in the database of the creative work protection server to determine similarities. At a next decision block 915, the creative work protection server determines if the similarities exceed a predetermined correlation threshold. If yes, then the creative work protection server stores creative text work name along with web page details or titles in the database and similarity beginning character number and ending character number, at a next block 931. Then, the processes of blocks 913 and 915 are repeated. If not at the decision block 915, at a next decision block 917, the creative work protection server determines if all of the creative text works of the registered owner are compared. If not, with a next creative text work, the processes of blocks 911, 913, 915 and 931 are repeated. In another embodiment, the comparison may occur on the basis of keywords, which is not shown in the flowchart.

If yes at the decision block 917, then the creative work protection server prepares a result page (from the stored information of similarities) containing vital statistics, name and web links of the text that contains similarities along with additional information, at a next block 919. Then, at a next block 921, the creative work protection server delivers the result page containing vital statistics and similarities with title and correlated characters. At a next decision block 923, the creative work protection server determines if more similarities within the same webpage or in another webpage (that belongs to the creative text works of the registered owner) or in the database files are found. If yes, then the processes of blocks 919 and 921 are repeated to generate addition result pages. If not, at a final block 925, the functionality ends.

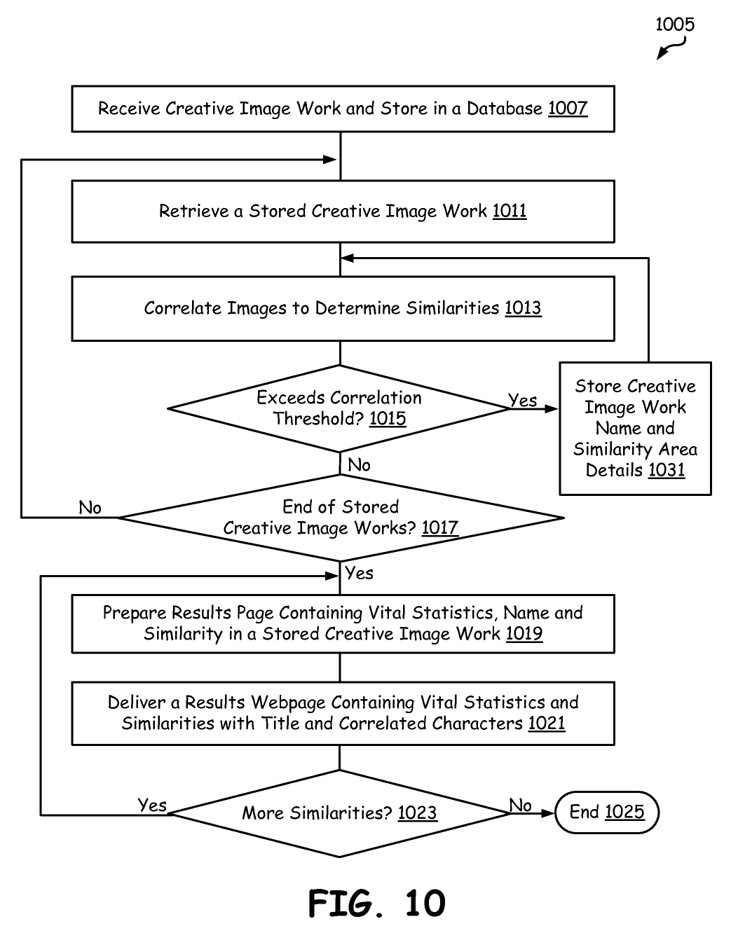

FIG. 10 is a flow diagram illustrating functionality 1005 of the creative work protection server of FIG. 1 in detail, with the creative work containing images in consideration. The detailed functionality concerning the creative work containing images begins at a block 1007, when the creative work protection server receives creative image works and stores them in a database. The creative work protection server provides webpage interfaces to registered owner of the creative image works to upload one or more creative image works.

At a next block 1011, the creative work protection server retrieves stored creative image work. At a next block 1013, the creative work protection server correlates images pixel by pixel (after converting formats to a predetermined image format and resizing the images) with that of web image content in major third party host servers and that in the database of creative work protection server to determine similarities. At a next decision block 1015, the creative work protection server determines if the similarities exceed a predetermined correlation threshold. If yes, then the creative work protection server stores creative image work name along with web page details and similarity area details, at a next block 1031. Then, the processes of blocks 1013 and 1015 are repeated. If not at the decision block 1015, at a next decision block 1017, the creative work protection server determines if all of the creative image works of the registered owner are compared. If not, with a next creative image work, the processes of blocks 1011, 1013, 1015 and 1031 are repeated.

If yes at the decision block 1017, then the creative work protection server prepares a result page (from the stored information of similarities) containing vital statistics, name and web links of the image that contains similarities along with additional information, at a next block 1019. Then, at a next block 1021, the creative work protection server delivers the result page containing vital statistics and similarities with title and correlated image areas. At a next decision block 1023, the creative work protection server determines if more similarities within the same webpage image or in another webpage image or images in the database are found. If yes, then the processes of blocks 1019 and 1021 are repeated to generate addition result pages. If not, at a final block 1025, the functionality ends.

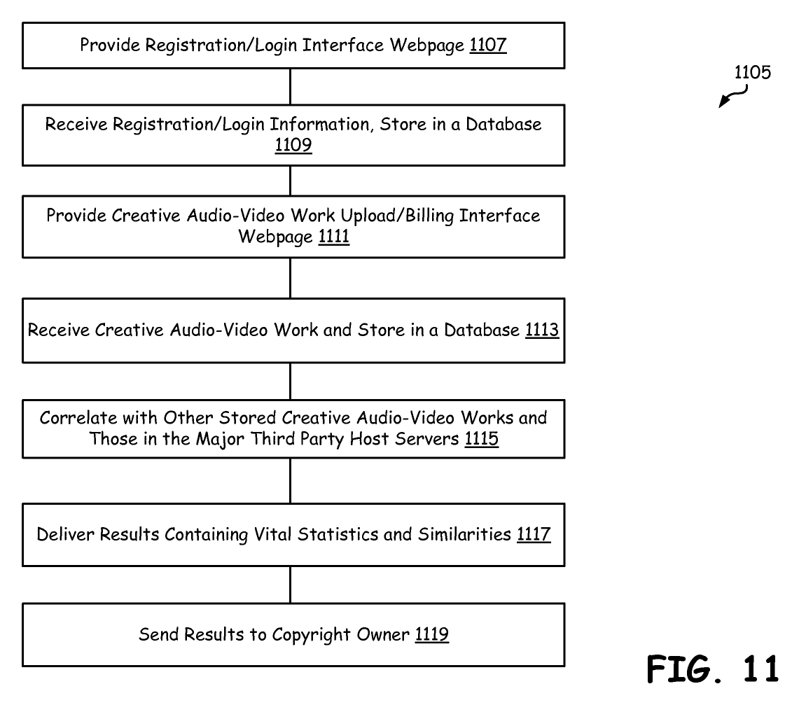

FIG. 11 is a flow diagram illustrating functionality 1105 of the creative work protection server of FIG. 1 in detail, wherein the creative work protection server identifies and reports similarity in creative works containing audio and video content. The functionality of the creative work protection server that deals with audio-video creative work content begins at a block 1107 when an owner of a creative audio-video work is provided with registration/login interface webpage. At a next block 1109, the creative work protection server receives registration information (for the first time) and stores this information in a database. In subsequent interactions, the creative work protection server verifies login information and allows the owner to access services of the creative work protection server. The registration information may contain user name, password, date of birth, address, email address and other relevant information.

At a next block 1111, the creative work protection server provides creative audio-video work upload/billing webpage interface. The owner may upload any number of creative audio-video works in subsequent visits (after initial registration), and the billing may occur on one of many possible ways. This includes a fixed price/creative audio-video work, fixed price/second of the creative audio-video work, fixed price/report generated for a predetermined period such as a week or month, etc. That is, the billing may occur immediately after uploading of creative audio-video works or may occur periodically based upon an agreement with the registered owner. The service may be provided for a fixed period of time such as one year or two years depending upon agreement with the registered owner.

At a next block 1113, the creative work protection server receives creative audio-video works and stores them in a database. At a next block 1115, the creative work protection server correlates the creative audio-video work with that of web content in the major third party host servers and that in the database of creative work protection server. Then, creative work protection server generates a report containing all of the titles and website links that contain audio-video content having similarities with that of content of creative audio-video works. At a next block 1117, the creative work protection server delivers results containing vital statistics of the creative audio-video works, along with similarities found. In a final block 1119, the creative work protection server sends results to the registered owner, and upon agreement with registered owner and host third party servers, to the major third party host servers.

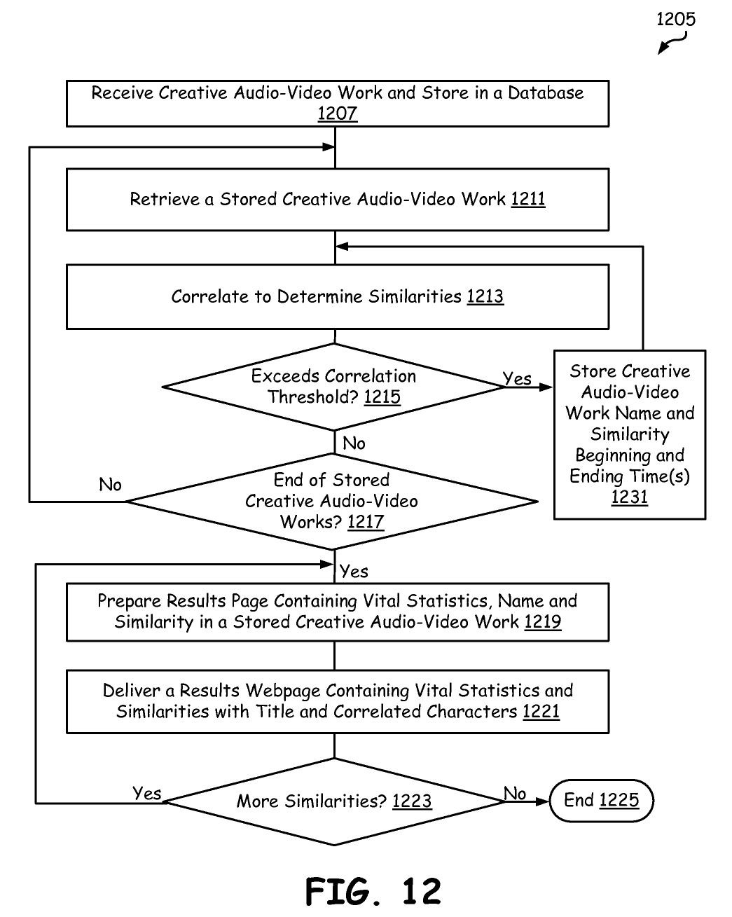

FIG. 12 is a flow diagram illustrating functionality 1205 of the creative work protection server of FIG. 1 in detail, with the creative work containing audio-video content in consideration. The detailed functionality concerning creative audio-video works begins at a block 1207, when the creative work protection server receives creative audio-video works and stores them in a database. The creative work protection server provides webpage interfaces to registered owner of the creative audio-video works to upload one or more creative audio-video works.

At a next block 1211, the creative work protection server retrieves stored creative audio-video work. At a next block 1213, the creative work protection server correlates audio-video works with that of web audio-video content in major third party host servers and that in the database of creative work protection server to determine similarities. In case of audio recordings, bit by bit comparison may be employed. Alternatively, in some cases, the creative work protection server may resort to converting the recordings to analog forms and then comparing them. In case of video recordings, the digital signatures are identified and compared as a first step. As a next step, the comparison of audio portion of the video recording is performed and then, if no similarities are found, the video portion of the recording are compared. The video portion comparison may occur on the basis of frame by frame comparison. Other methods of comparison are also contemplated.

At a next decision block 1215, the creative work protection server determines if the similarities exceed a predetermined correlation threshold. In case of audio recordings, the correlation threshold may be a predetermined number of adjacent bits and in case of video this may be a predetermined number of adjacent frames. If yes at the decision block 1215, then the creative work protection server stores creative audio-video work name, vectors for web audio-video content and the database content along with similarity beginning and ending times, at a next block 1231. Then, the processes of blocks 1213 and 1215 are repeated. If not at the decision block 1215, at a next decision block 1217, the creative work protection server determines if all of the creative audio-video works of the registered owner are correlated. If not, with a next creative audio-video work, the processes of blocks 1211, 1213, 1215 and 1231 are repeated.

If yes at the decision block 1217, then the creative work protection server prepares a result page (from the stored information of similarities) containing vital statistics, name and web links of the audio-video content that contains similarities along with additional information, at a next block 1219. Then, at a next block 1221, the creative work protection server delivers the result page containing vital statistics and similarities with title and correlated audio-video times. At a next decision block 1223, the creative work protection server determines if more similarities within the same audio-video content or in another audio-video content are found. If yes, then the processes of blocks 1219 and 1221 are repeated to generate addition result pages. If not, at a final block 1225, the functionality ends.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A creative works protection infrastructure supporting a plurality of creative works, each of the plurality of creative works comprising creative works video and associated creative works audio, the creative works protection infrastructure comprising:
a hosting server; a client device that sends to the hosting server a request to upload a client media file, the client media file comprising client video and associated client audio; a registry database; a registry interface that supports the storage in the registry database of data associated with at least a portion of the creative works audio of each of the plurality of creative works;
a processing system, communicatively coupled to the registry database, that attempts to find correlation between the data stored in the registry database and the associated client audio; and
the processing system, based on the attempted correlation, selectively generates a message indicating that the client media file is at least likely to be a derivative of one of the plurality of creative works.

2. The creative works protection infrastructure of claim 1, wherein the processing system delivers the message to a user of the client device.

3. The creative works protection infrastructure of claim 1, wherein the processing system generates the message for review via the registry interface.

4. The creative works protection infrastructure of claim 1, wherein the registry interface comprising a web browser interface.

5. The creative works protection infrastructure of claim 1, wherein the registry interface comprising an email interface.

6. The creative works protection infrastructure of claim 1, wherein the registry interface comprising a software interface.

7. The creative works protection infrastructure of claim 1, wherein the message includes a license payment option.

8. The creative works protection infrastructure of claim 1, wherein the processing system generates the message if both significant correlation is detected and a user of the client device is not already licensed.

9. A creative works detection server supporting a plurality of creative works, each of the plurality of creative works comprising creative works video and associated creative works audio, the creative works detection server being communicatively coupled to a first hosting server and first client device, the first hosting server receiving a request from the first client device to upload a client media file to the first hosting server, the client media file comprising client video and associated client audio, the creative works detection server comprising:
a database that stores data associated with at least a portion of the creative works audio of each of the plurality of creative works;
an interface associated with the storing of the data associated with the at least the portion of the creative works audio of each of the plurality of creative works in the database; a processing system that compares at least a portion of the associated client audio with the data stored in the database; and
the processing system concludes that the client media file is at least likely to be a derivative of one of the plurality of creative works.

10. The creative works detection server of claim 9, wherein the processing system sends a message to the hosting server regarding the conclusion.

11. The creative works detection server of claim 9, wherein the processing system sends a message via the interface regarding the conclusion.

12. The creative works detection server of claim 9, wherein the interface comprising a web browser interface.

13. The creative works detection server of claim 9, wherein the interface comprising an email interface.

14. The creative works detection server of claim 9, wherein the interface comprising a software interface.

15. A creative works infrastructure supporting a plurality of creative works, each of the plurality of creative works comprising at least one of creative works text, creative works images, creative works video, creative works audio, and creative works video with associated creative works audio, the creative works protection infrastructure comprising:
a hosting server; a client device that sends to the hosting server a request to receive a client file, the client file comprising at least one of client text, client image, client video, client audio, and client video with associated client audio;
a registry database; a registry interface that supports the storage in the registry database of data associated with at least a portion of each of the plurality of creative works;
a processing system, communicatively coupled to the registry database, that attempts to find correlation between the data stored in the registry database and the associated client file; and
the processing system, based on the attempted correlation, selectively generates a message indicating that the client media file is at least likely to be a derivative of one of the plurality of creative works.

16. The creative works infrastructure of claim 15, wherein the processing system delivers the message to a user of the client device.

17. The creative works infrastructure of claim 15, wherein the processing system generates the message for review via the registry interface.

18. The creative works infrastructure of claim 15, wherein the registry interface comprising a web browser interface.

19. The creative works infrastructure of claim 15, wherein the registry interface comprising an email interface.

20. The creative works infrastructure of claim 15, wherein the registry interface comprising a software interface.
